(19) United States
(12) Patent Application Publication
(10) Pub. No.: US 2018/0157748 A1
(43) Pub. Date: Jun. 7, 2018

(54) Computer Application for Medical Device Collaboration

(71) Applicant: Mary Beth Privitera, Mason, OH (US)

(72) Inventor: Mary Beth Privitera, Mason, OH (US)

(21) Appl. No.: 15/368,659

(22) Filed: Dec. 4, 2016

(51) Int. Cl. G06F 17/30; G06F 19/00

(52) U.S. Cl. CPC G06F 17/30864; G06F 19/3425; G06F 19/328; G06F 19/324; G06F 19/321

(57) ABSTRACT

The disclosure is a tool that facilitates the idea development process while integrating compliance/regulatory guardrails; companies can adapt the tool as requirements change, clinicians can participate with confidence, and technical resources step through a routine process with quick access to reference data that optimizes their learning and sharing.

### CROSS REFERENCE TO RELATED APPLICATIONS

This present patent applications claims priority to the U.S. Provisional Patent Application Ser. No. 62/269,968 filed Dec. 12, 2015, the disclosure of which is incorporated herein by reference.

This Non-Provisional patent applications claims priority to the Provisional patent of the same name filed received by the USPTO on Dec. 19, 2015 with the Application No. 62/269,968, confirmation #2535, and EFS ID#24419352

### FIELD OF THE INVENTION

The described invention is a computer application that provides reference information and a stepwise process for cross functional collaboration in the development, use and use related monitoring of medical devices.

### INTRODUCTION TO THE INVENTION

A computer application is a program designed to perform coordinated functions, tasks or activities which benefit the user. The goal of this computer application is to bring together those who have unsolved clinical problems with those who solve them for the purposes of supporting medical device development.

The computer application enables users involved in either the use or development of medical devices to record ideas and problems, identify collaborators, and interact with collaborators at their convenience. In enables a means to define the scope of research for development such as contextual inquiry, ethnography, usability assessment, exploration or surveillance. Additionally, it enables users to record events of interest in real time and in appreciation of patient privacy laws. Users may document findings of the research within the application while referencing information related to the topic such as anatomical/physiological data, other development information such as risk analysis. The computer application provides a resource for the medical device development process, intellectual property basics, business influencers on medical device development and regulatory/agency basics. In addition, it provides the ability to facilitate annotations and analytics on captured information for the purposes of clinical application research, product development or regulatory submissions such as FDA 510k registrations.

The computer application deals with a number of needs in the collaboration process
Ideation in of itself is a process—providing the user with a stepwise approach to problem definition and data gathering will facilitate more effective concept development. Ideation for medical device development requires knowledge of prior research studies that has already been complete; these studies may include clinical trials, anatomical investigation, physiologic monitoring, or technology development.
Medical ideation requires significant reference information—providing the user with quick reference to anatomical, procedural, market, and technical data will facilitate communication between team members and provide support for individual process steps
Idea capture should be done with proper documentation—providing the user with simple tools to document idea's with timestamps and reference points helps assure that these idea's are captured in a manner that facilitates patent development/ownership rights
Clinical Inputs must be compliant with patient rights, providing the user with reference tools that create awareness to the latest regulatory boundaries and help facilitate communication without extending past those boundaries will help build confidence in the clinician inventors and ease their concern that patient's rights may be compromised.
Discoveries within the research must be is documented to allow proper analysis and understanding. This documentation may include gathering all of the above information into a searchable and analytical database for quick reference and decision making support. This may build a reference database required to generate and populate data collection forms as required for device development such as intellectual property disclosure, process documentation or regulatory submission.
Understanding of Post Market release data provides insight into safety and effectiveness of the medical device use. Post market surveillance is a collection of processes and activities to monitor the safety and effectiveness of medical device once they are on the market.

A review of currently available Android and Apple computer applications shows that there are a number of applications that support each area of need, but none that integrate the information in a manner that is intended to facilitate the business process intended by this invention.
Ideation—There are applications that discuss the mental process of idea development and are intended to encourage thought (Great Thoughts by MConverge; Creative Thinking Idea Conception: Easy Ways to Maximize Your Creativity by appz) but none of these provide a stepwise approach to product ideation and specifically describe the unique steps that should be considered when developing a medical device.
Medical Reference Data—There exists a wide range of medical reference data, most with very targeted objectives for anatomical data (3D Human Anatomy by Image Magic Studio's), clinical understanding (I'm Expecting by MedHelp International), training (ECGRhythms Quiz by Anesoft), clinical management (Dosecast by Montuno Software) or procedural techniques (Message Technique by Real Bodywork). There do not appear to be any of these reference applications that link directly to the ideation/problem solving process.
Idea Capture—There exists a wide range of design tools, most with very targeted objectives for sketching (Sketch Guru by Bejoy Mobile), drawing (Tech Draw by Kelly Technology), note taking (Whiteboard by Kevn Adonis), estimate (Home Improvement Pro by Egghead Design) or schedule (Schedule Planner Classic by Digi 117). There do not appear to be any of these applications that link directly to the ideation/problem solving process to a formal means for capturing the key elements of design (Unmet need, design considerations, functional breakdown, potential solutions, prioritized solutions, review, and detail design). Further, there exist applications that describe the patent search process (Patent Search Pro by Web Solutions) and application process (How to Get a Patent by KoolAppz) but there does not appear to be any application that specifically seeks to document the idea in a format specifically intended to support the patent application process (inventor, date stamp, background, embodiment, images).
Compliance—There exists a wide range of reference tools related to HIPAA that support providing patient data (HIPAA Compliance App by Snappii), authorizing use of data (My Med Auth by PleadFast), and designating authority (MyHealthProxy by PleadFast); however none of these applications not appear to link directly to the ideation/problem solving process. Further, other regulatory requirements that would relate to medical product research such as the Sunshine Act do not appear supported by computer applications.

### BRIEF DESCRIPTION OF THE DRAWINGS

FIG. 1 is an exemplary screen shot of a mobile device login screen in accordance with the instant disclosure.

FIG. 2 is an exemplary screen shot of a mobile device build profile in accordance with the instant disclosure.

FIG. 3 is an exemplary screen shot of a mobile device HIPPA agreement in accordance with the instant disclosure.

FIG. 4 is an exemplary screen shot of a mobile device main menu in accordance with the instant disclosure.

FIG. 5 is an exemplary screen shot of a mobile device ideate and collaborate menu in accordance with the instant disclosure.

FIG. 6 is an exemplary screen shot of a mobile device observe and record menu in accordance with the instant disclosure.

FIG. 7 is an exemplary screen shot of a mobile device discover menu in accordance with the instant disclosure.

FIG. 8 is an exemplary screen shot of a mobile device ideate and collaborate menu in accordance with the instant disclosure.

FIG. 9 is an exemplary screen shot of a mobile device ideate menu in accordance with the instant disclosure.

FIG. 10 is an exemplary screen shot of a mobile device with an exemplary anatomy and drawing interface to view and annotate in accordance with the instant disclosure.

FIG. 11 is an exemplary screen shot of a mobile device with an exemplary text editor to record notes in accordance with the instant disclosure.

FIG. 12 is an exemplary screen shot of a mobile device with a voice recorder to record sound and notes in accordance with the instant disclosure.

FIG. 13 is an exemplary screen shot of a mobile device projection selection menu in accordance with the instant disclosure.

FIG. 14 is an exemplary screen shot of a mobile device depicting a status in accordance with the instant disclosure.

FIG. 15 is an exemplary screen shot of a mobile device with a collaborator find menu in accordance with the instant disclosure.

FIG. 16 is an exemplary screen shot of a mobile device prompting collaborator connections via on-line resources in accordance with the instant disclosure.

FIG. 17 is an exemplary screen shot of a mobile device depicting a contacts listing in accordance with the instant disclosure.

FIG. 18 is an exemplary screen shot of a mobile device observe and record menu in accordance with the instant disclosure.

FIG. 19 is an exemplary screen shot of a mobile device with a HIPPA recordation menu in accordance with the instant disclosure.

FIG. 20 is an exemplary screen shot of a mobile device HIPPA agreement in accordance with the instant disclosure.

FIG. 21 is an exemplary screen shot of a mobile device HIPPA agreement in accordance with the instant disclosure.

FIG. 22 is an exemplary screen shot of a mobile device showing patient records pursuant to a HIPPA agreement in accordance with the instant disclosure.

FIG. 23 is an exemplary screen shot of a mobile device depicting a first video in an operating room or clinical setting in accordance with the instant disclosure.

FIG. 24 is an exemplary screen shot of a mobile device depicting a second video in an operating room or clinical setting in accordance with the instant disclosure.

FIG. 25 is an exemplary screen shot of a mobile device showing a video menu in accordance with the instant disclosure.

FIG. 26 is an exemplary screen shot of a mobile device discover menu in accordance with the instant disclosure.

FIG. 27 is an exemplary screen shot of a mobile device providing information on medical device development in accordance with the instant disclosure.

FIG. 28 is an exemplary screen shot of a mobile device providing information on business development in accordance with the instant disclosure.

FIG. 29 is an exemplary screen shot of a mobile device providing regulatory information in accordance with the instant disclosure.

FIG. 30 is an exemplary screen shot of a mobile device providing intellectual property information in accordance with the instant disclosure.

FIG. 31 is an exemplary process flow diagram in accordance with the instant disclosure.

### DETAILED DESCRIPTION

### Target Audience:

The following exemplary embodiment may be utilized by physicians, nurses, techs, PA's, care providers, patients, designers, engineers, marketing and business development personnel from medical device industry, academic faculty with focus in medical devices or translational science.

The computer application may provide a means to document characteristics of research participants and product effectiveness for manufacturers of medical devices who are required by regulating agencies to maintain surveillance of product performance.

### Features:

The interface is designed for simplicity; the main menu consists of 3 sections detailed below:
Ideate & Collaborate
Observe & Analyze
Discover

### Ideate & Collaborate

Ability for users to co-create/collaborate
   Draw an idea using pull down anatomical reference menu
      System automatically provides references based upon area of specialty selected in profile
   Describe an idea or problem by typing a description
   Ability to record medical device use challenges for post market surveillance
   Dictate an idea or problem
      Share experiences with device use
   Each exploration is tagged with the author that cannot be removed.
Ability to share information with contacts for collaboration
   Select from existing contacts
   Reach out within the system and identify collaborators
      Reach out externally through social media such as Linked In or Doximity in order to identify potential collaborators.
   Ability to send notification to collaborative partners has posted something or has a specific request
      Ability for any user to request follow-up discussion

### Observe & Analyze

Ability to consent patients within the system
Ability to capture clinical or non-clinical situations in real time using a computer camera.
   Dictate, video or image a clinical situation—save it and send it.
   Maintain a record of patient consent with observational content
   Maintain a record of recorder identity or research participant
Ability to annotate observed situations with explanatory event marking
Ability to analyze annotations and produce a trend report as an automatic function of the system using data collection forms based on the scope of the research which may meet regulatory guidelines related to research participants.
   Data collection forms are tools that facilitate consistent collection of information.
   This could be used for a contextual inquiry program, usability testing or for post-market surveillance
Ability to link the research to prior research studies or external research studies such as risk analysis, marketing studies or clinical trials which may include stored files outside of the computer application
Ability to link to information regarding existing products related to the research which may include information related to clinical performance, use or safety data.
Ability to automatically analyze the data or including the means of running a specific query.
Ability to update the accessed data to include collected research observations at anytime

### Discover

Ability for all to explore various medical device development processes
   Details regarding stage-gate process, waterfall process and spiral development process are described.
      All reference pages visually describe overall process, key acronyms, requirements for medical device development
Ability to explore influencers that impact development and business decisions
   Details regarding current trends in device usage and development
   Details regarding and laws or taxes which have the potential to impact device development
Ability to explore regulatory/agency requirements and/or processes
   Details regarding regulatory pathways and impact on the development process
   Details regarding current changes in policy that impact development in both domestic and international markets
   Ability to correlate or associate discoveries in the data required for regulatory submission and then automatically generate a report that may be intended for regulatory submission or external use

### Other Considerations:

HIPPA Compliance (or other regulatory rule compliance)—
   The Proposed Computer Application may require that all participants sign patient confidentiality forms and a promise to maintain sensitivity to patient information
   All users may be required to login and have data protected
   Ability to choose “make profile public” or parts of it
   Ability to choose “make clinical problem public or parts of it or none”
Inventor Recognition—All data that holds the potential for further intellectual property has confirmation that its tied to a particular person and recorded as theirs. In this instance, any images produced within the app, dictated concepts and/or written concepts may be marked with identification of its creator.
Social Media Interface—The computer application may have the ability to appropriately integrate social media. Users may opt to search social media such as LinkedIn or Doximity in order to locate potential collaborative partners.
Confidential Data Transfer—All patient data may be solely maintained within the computer application and users may have the ability to export the data into appropriate systems such as a desktop computer or upload to a clinical system.
   Scenario 1 of Device Function: Physician with Clinical Challenge

Dr. XXXX is a general surgeon working with a neurosurgeon in the placement of a shunt that directs extra csf from the brain to the abdomen. While, dr. YYYY the neurosurgeon places the drain in the brain, Dr. XXXX must create a subcutaneous tunnel from the abdomen to the neck. In order to do this he must tunnel around the clavicle and then target to meet Dr. YYY.

This has been a challenging problem for him for awhile and he′d like to find a better way.

Using the Proposed Computer Application, he readily gains patient consent (pull up form, electronic approval through signature on screen, fingerprint acknowledgement, audio acknowledgment, other means or a combination of these means) then snaps a few images prior to the procedure to capture the patient habitus. Next, he may dictate overall approach and requests the charge nurse to take a few images intermittently throughout the case. After the case, he dictates a full description of the problem. The system may automatically associates his identification to the images in preparation for sending to the design team.

Once completed, the system may ask what he would like to do: annotate further, save information, and/or send file.

He may decide to send the file to a targeted design team. He scrolls through his design contacts and hits send. The system sends a notification to the design team that they have a message; that message may require acknowledgement of the confidential nature of the data. Upon opening by the design team, a notification of receipt may be sent to Dr. XXXX.

The design team, reads and absorbs the images and may need to ask a few questions to Dr. XXX. The Proposed Computer Application, the design team may annotate the images/video/dictation and sends it back to Dr. XXXX assuring clarity of the communication. All communication is may be contained within the computer application and may be searchable both through time stamps and image links.

### Scenario 2: Design Team Reaches Out to Physicians for Collaborative Design

After receiving several cases describing a clinical problem, the design team puts together a design brief to review with Dr. XXXXX, Dr. YYYYY, Dr. FFFF and Dr. QQQQQ. Using the Proposed Computer Application project proposal template, the design goal & preliminary design requirements may be drafted in a standardized manner. Once completed, the Proposed Computer Application may asks the team what would they like to do: save and/or send. The team decides to send it to clinical partners for review.

The team selects a few clinical partners, possibly using the contact linked to the application. The Proposed Computer Application may ask if the design team would like the discussion to be private (one on one) or public (as a group-public only to invitees not public/public).

The team may decide to hold one on one discussion. Within the Proposed Computer Application, the team then selects the appropriate anatomy using linked anatomical reference data and creates line drawings for the discussion purposes. Additionally, reference data related to the actual or proposed devices can be references and the appropriate device components/images may be selected (control buttons, hand tool shapes, end effector shapes, etc.) and linked to the communication. Once a discussion package is complete, the team may requests an interactive session with the physicians. This session may be done strictly as a series of electronic messages back and forth with the clinical partner or may be part of a interactive web communication; in either approach the entire communication stream may be captured for later reference.

### Scenario 3: What's the Status of My Project?

As a collaborative project moves through the product development process, a status icon may provide a sense of progress as move through a diagram of the overall product development process. Within the system there may be a place to make comments or add questions not only to individual data elements but also to the timeline; all contributors to the process may have the opportunity to exchange opinions in this manner. This section is like a blog on program status. The system automatically tracks progress by requesting an update from the design team at a prescribed time.

### Scenario 4: What is the Process of Developing a Medical Device?

Not all contributors to the design of a product have a complete understanding of the overall process. The Proposed Computer Application may include an education forum with sections on the overall process including: identifying an opportunity, developing a business/marketing plan, regulatory, etc. This information may be similar to information provide in this particular reference: http://ucsim.uc.edu/blog/unity/poc-cent-medical-simulation-system/

This element of the Proposed Computer Application may prove to be particularly relevant as industry standards change over time.

System Drawings/Figures—the following figures and explanations provide representative examples of how the system may function but are not fully encompassing of all potential embodiments of the invention.

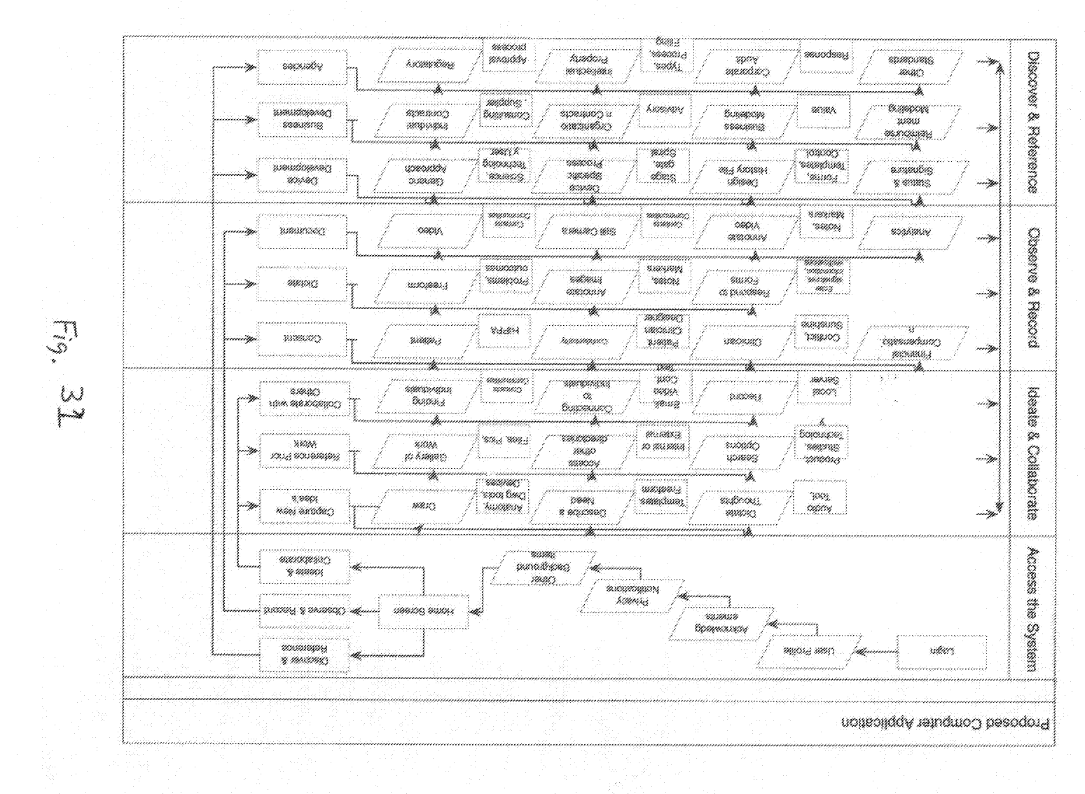

FIG. 31—Exemplary Network Diagram

The network diagram above provides an example of potential features and organizational structure for the Proposed Computer Application. The tool many include all or portions of the features shown above and may include additional functionality either directly in the principle program or via linkage to other computer programs.

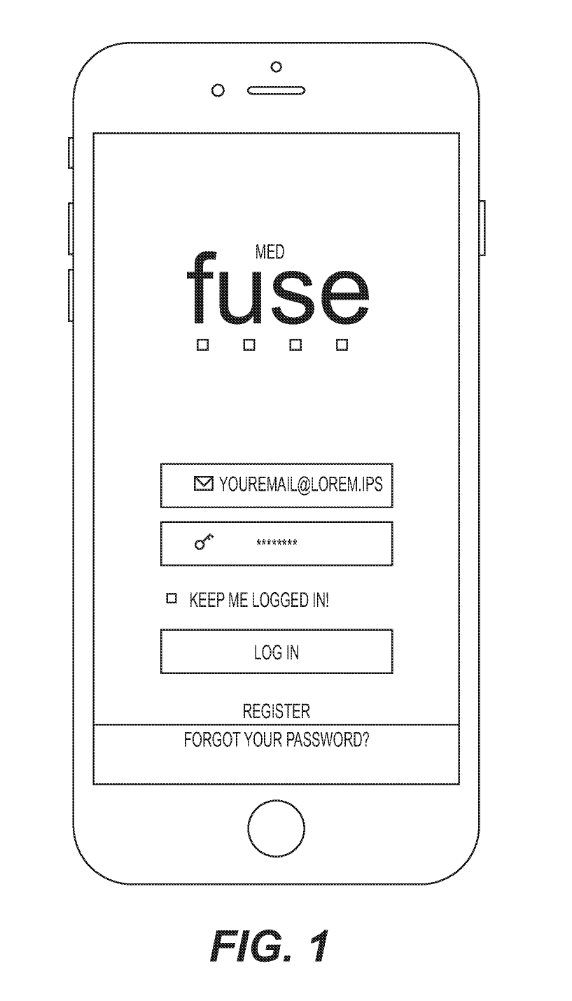

The organization of Proposed Computer Application may follow FIG. 1 or may link the features in alternative means that are more appropriate for the individual user. The organization may further be customizable to facilitate better user interface.

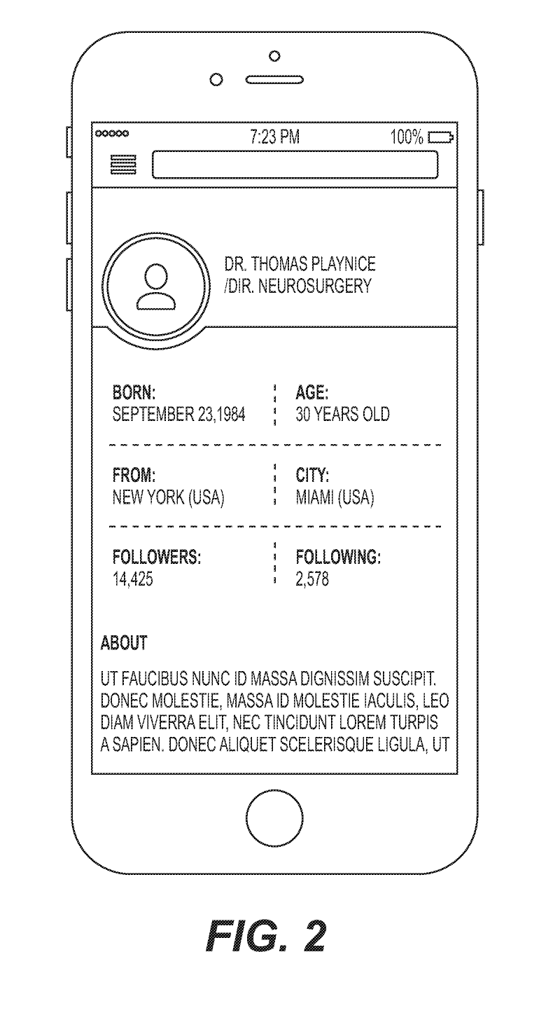

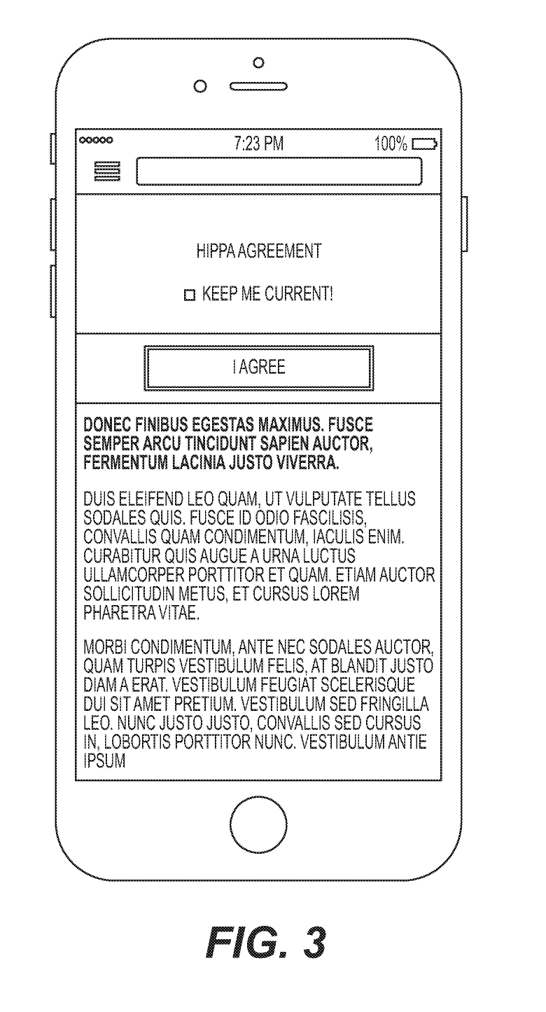

FIGS. 1-4—Login, Profile and Main Menu
Login—Users login to assure data is managed in a confidential manner. The data can be maintained locally or integrated into larger databases.
Profiles—Users and collaborators can input their data which can be linked to the ideation process to support ownership/patent submission process and can be linked to the compliance requirements.
Compliance Prompts—Immediately users would be prompted to consider compliance matters such as HIPPA to support patient privacy or other compliance matters that are important to the company conducting the research. Access to the other aspects of the tool can be restricted until these considerations are addresses and recorded.
Access to the Tool—Upon completion of the key reference data the main menu may be displayed/become active,

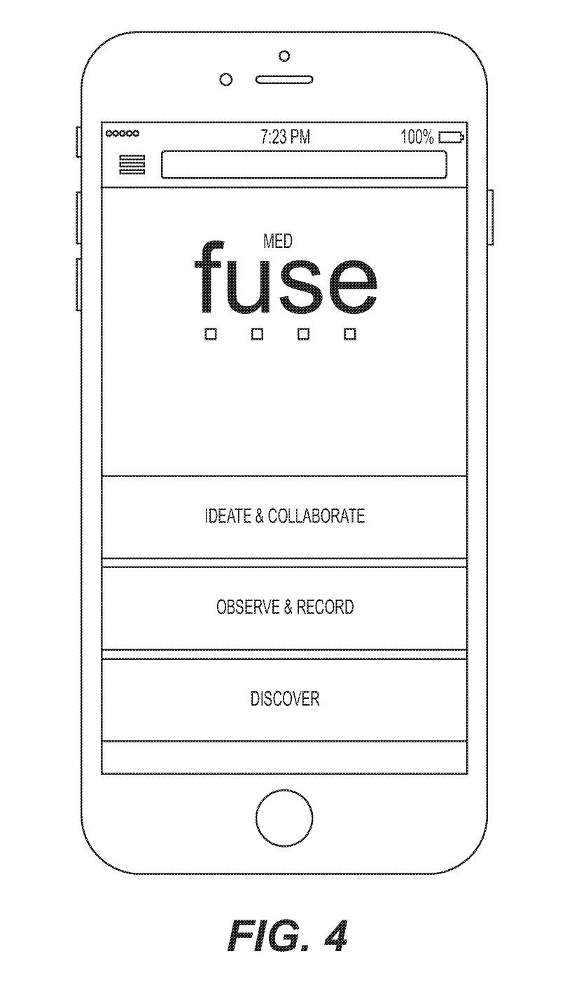

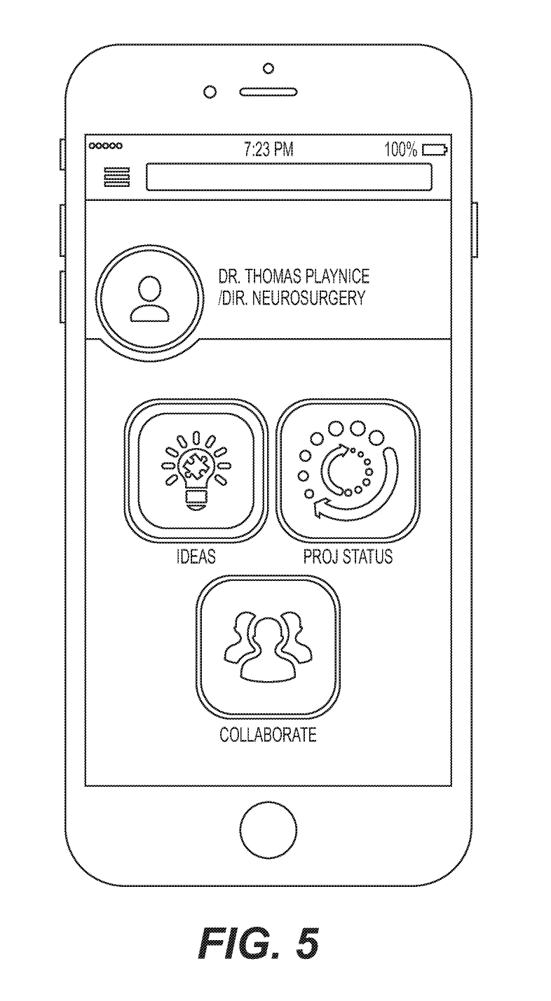

FIGS. 4-7—Secondary Menu's

The secondary menu's enables quick access to one or all of the key functional utilities within the app. It can be envisioned that the tool can be customized in many ways and additional functions added beyond the 3 core features defined herein.
Idea & Collaborate
Observe & record
Discover

Each of these secondary menu's may provide access to tools that are embedded in this specific application or provide linkage to other tools that can be run in parallel with or separately,

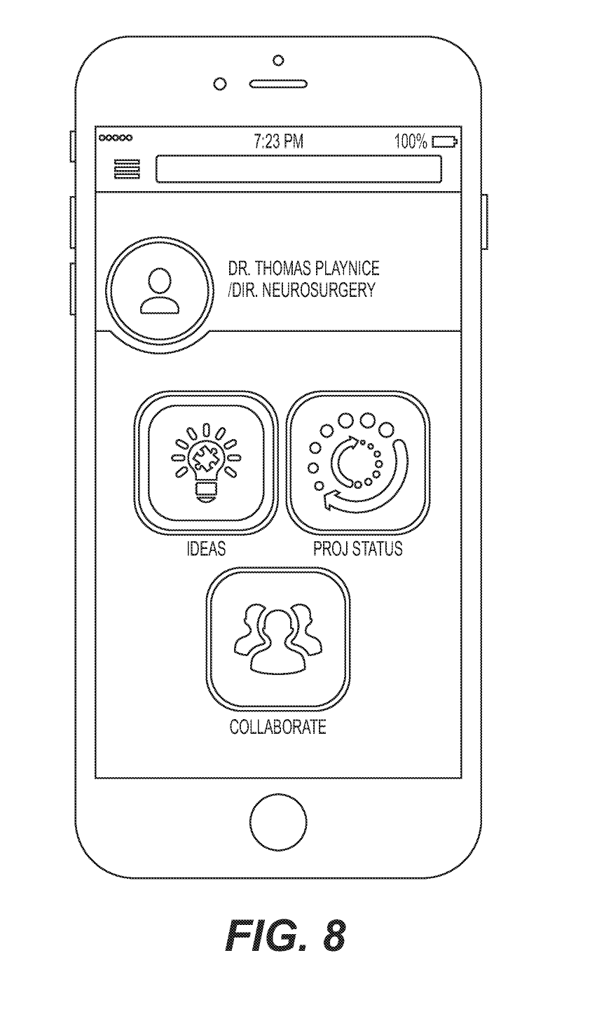

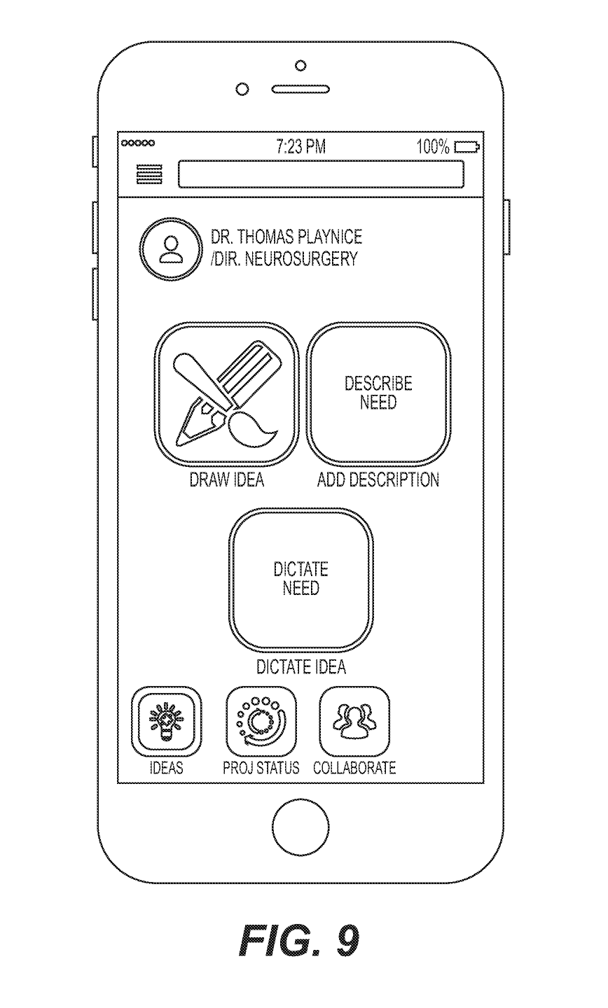

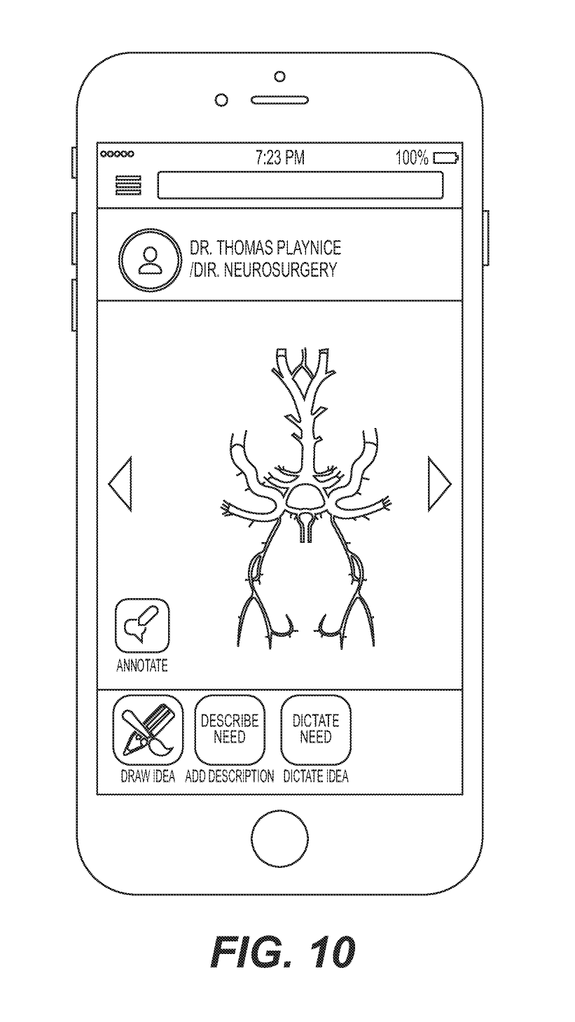

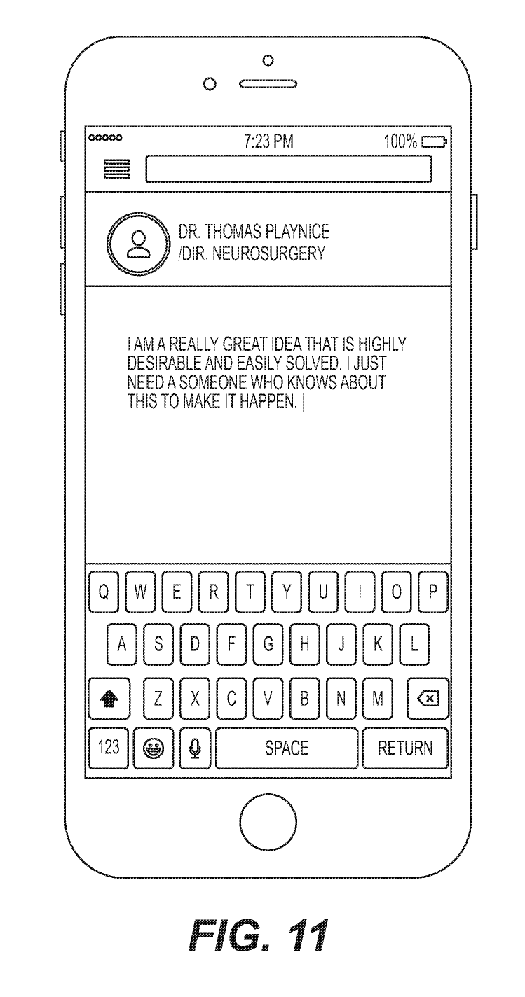

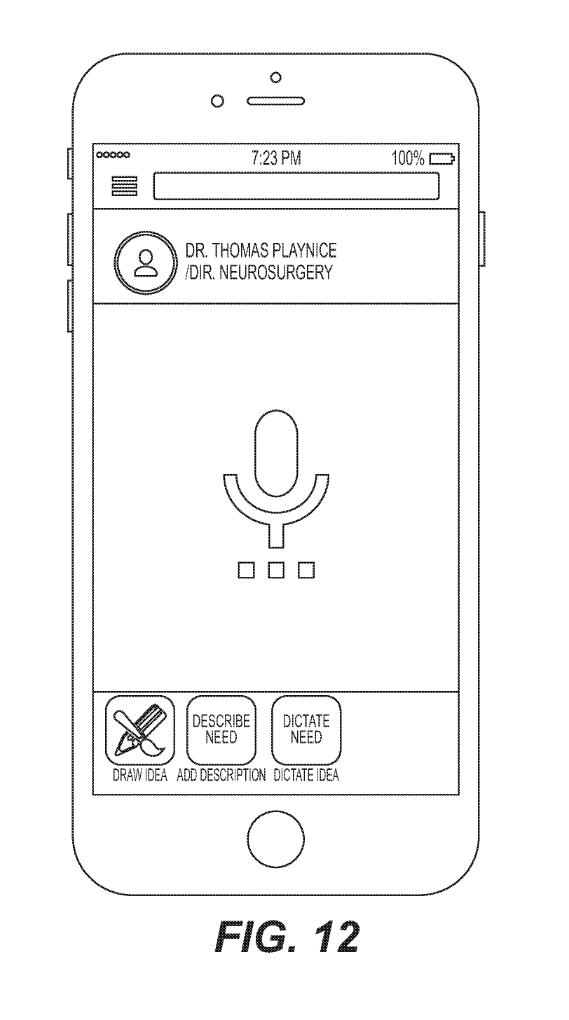

FIGS. 8-12 Ideate & Collaborate-Sub-Level 1 (Lightbulb Icon) Ideate

Users can ideate new ideas or record problems they encounter. From Ideate & collaborate sub-level 1 users can
Draw and annotate from an anatomical database or simply draw their ideas—these tools can provide for sketching, engineering drawings, image taking/manipulation, and other means for visual capture
Type a concept or problem as well as dictate notes to facilitate proper context around the visual images
Organize data to support proper idea capture in support of patent submission

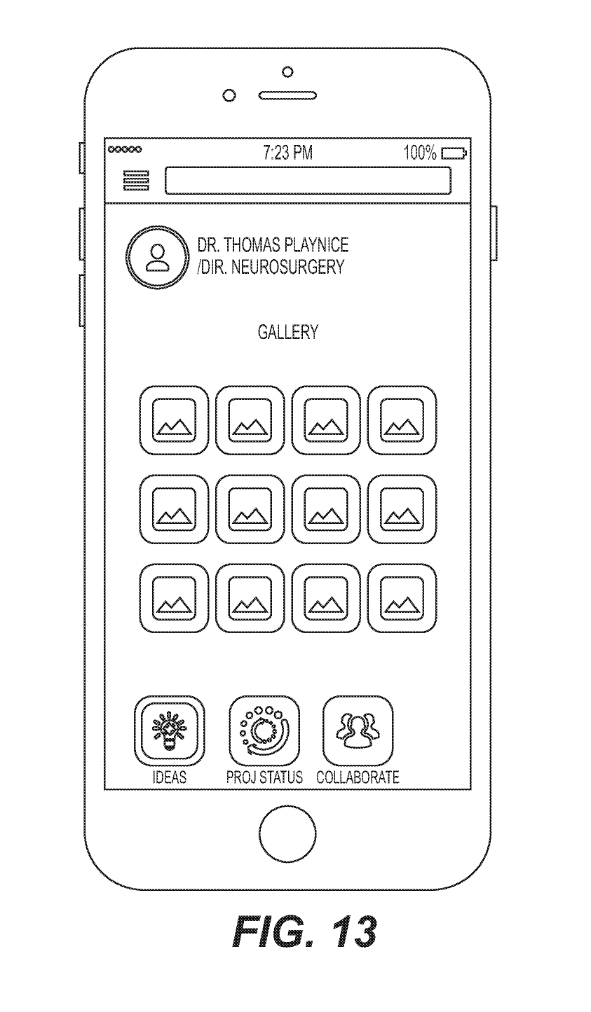

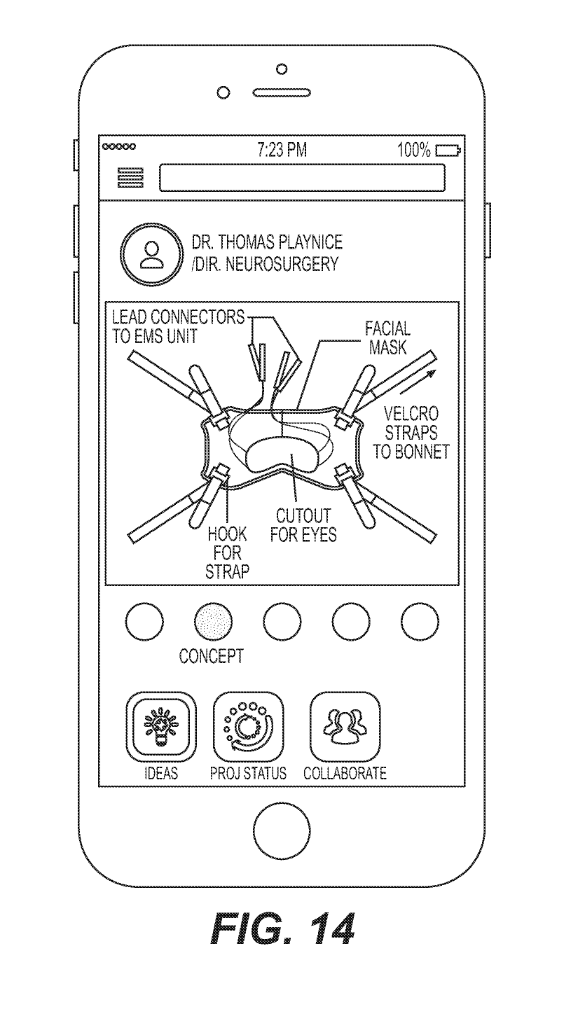

FIGS. 8, 13, and 14 Ideate & Collaborate Sub-Level 2 Project Status

Users can reference prior idea's/notes captured
Gallery—provides reference via time or project groupings to facilitate access and linked data management

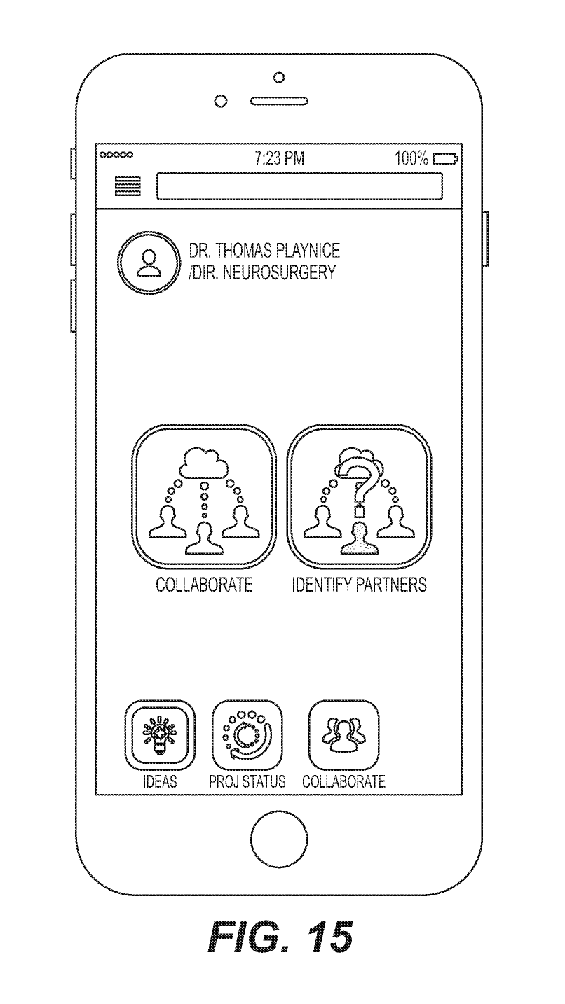

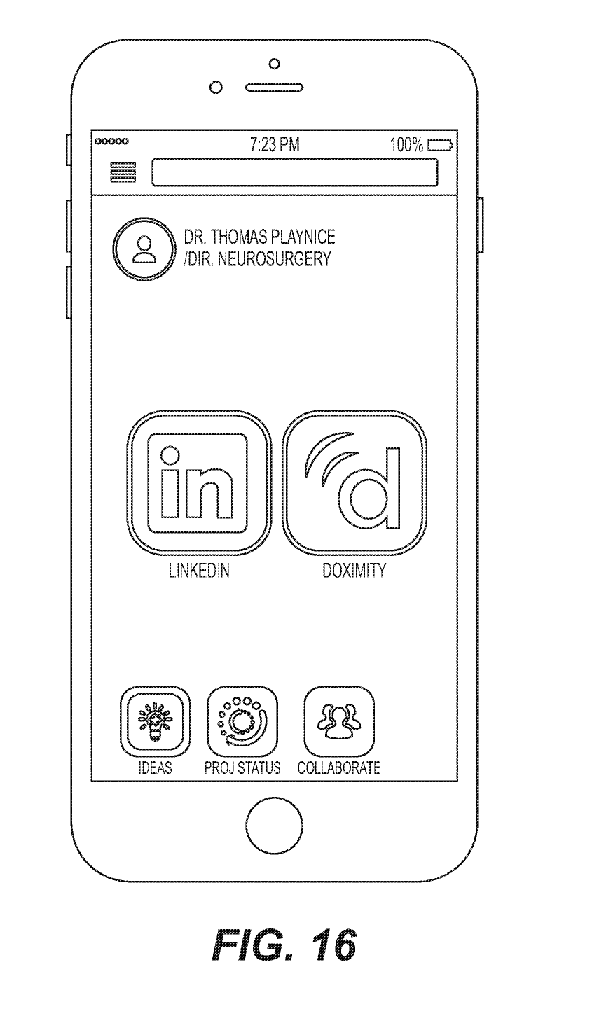

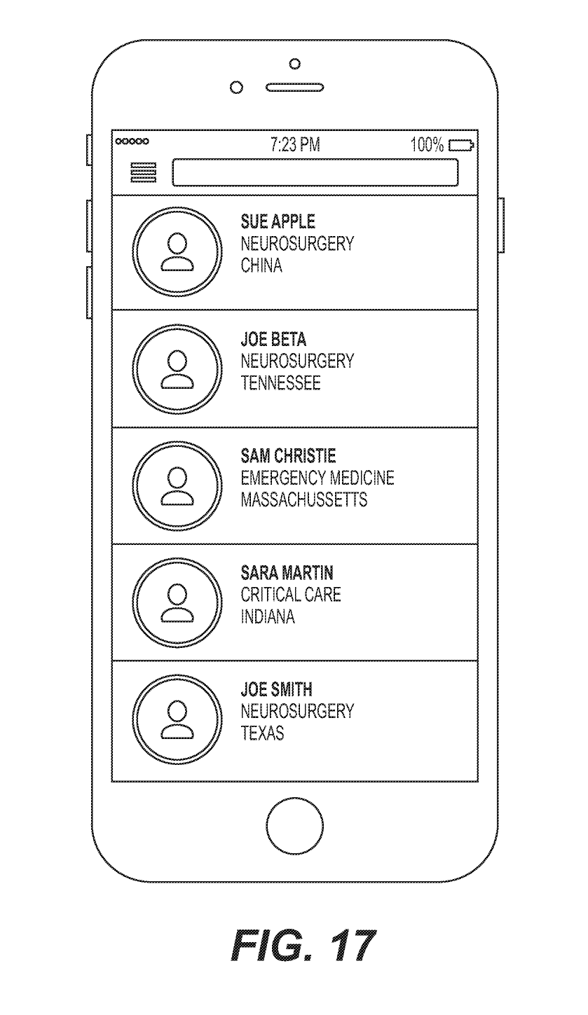

FIGS. 8, 15-17 Ideate & Collaborate Sub-Level 3 Collaborate

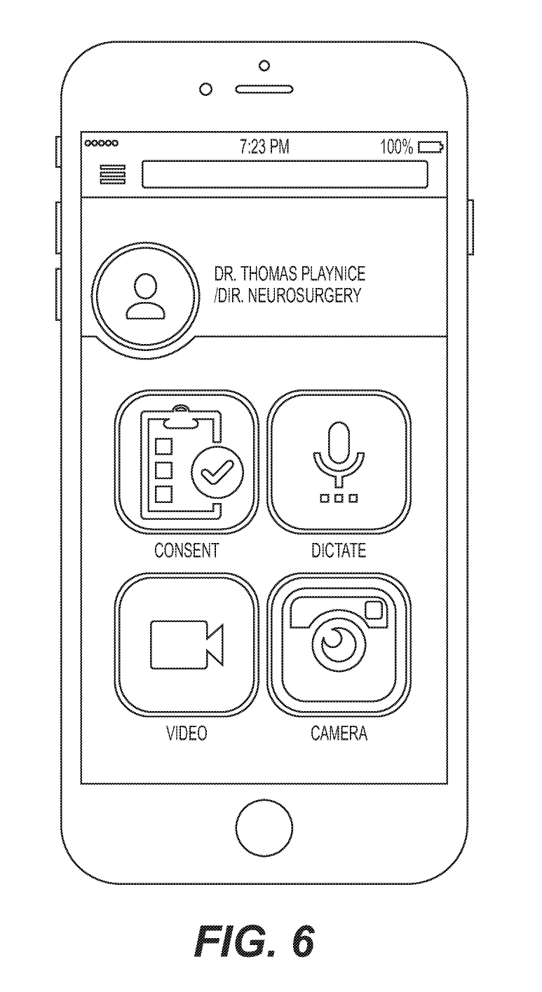

FIG. 6 highlights the process for inviting contact s to collaborate. This is done through contact s which exist in the system or by connecting outward through professional social media outlets such as LinkedIn or Doximity.

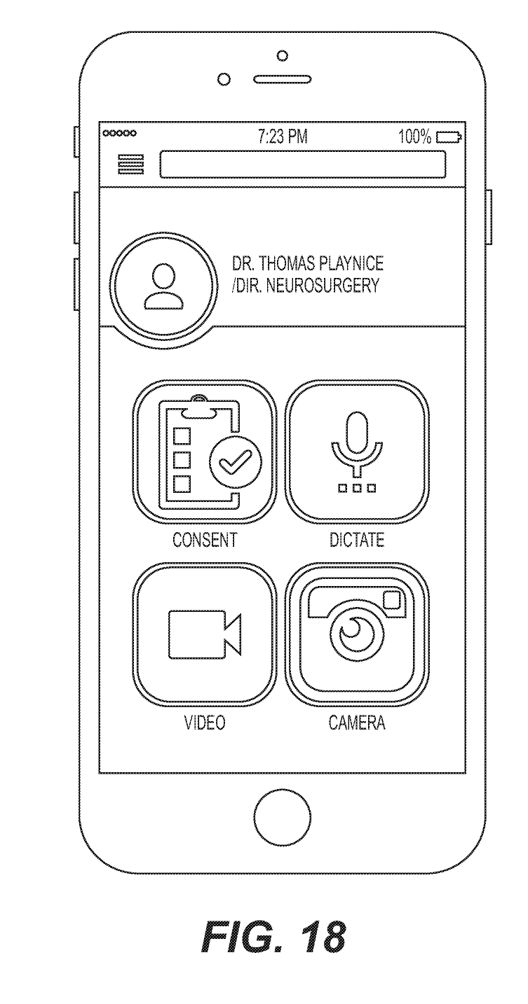

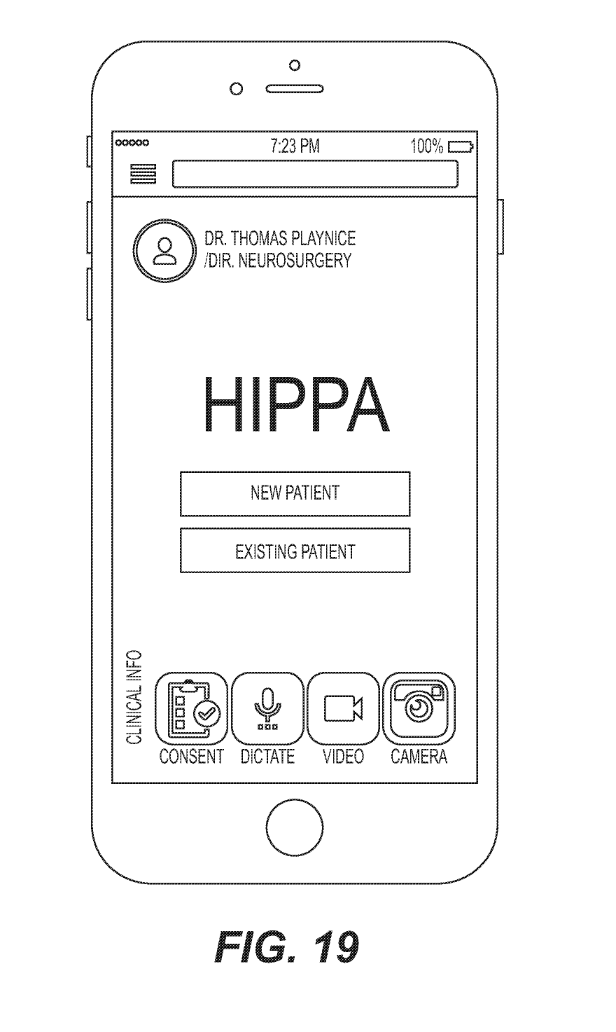

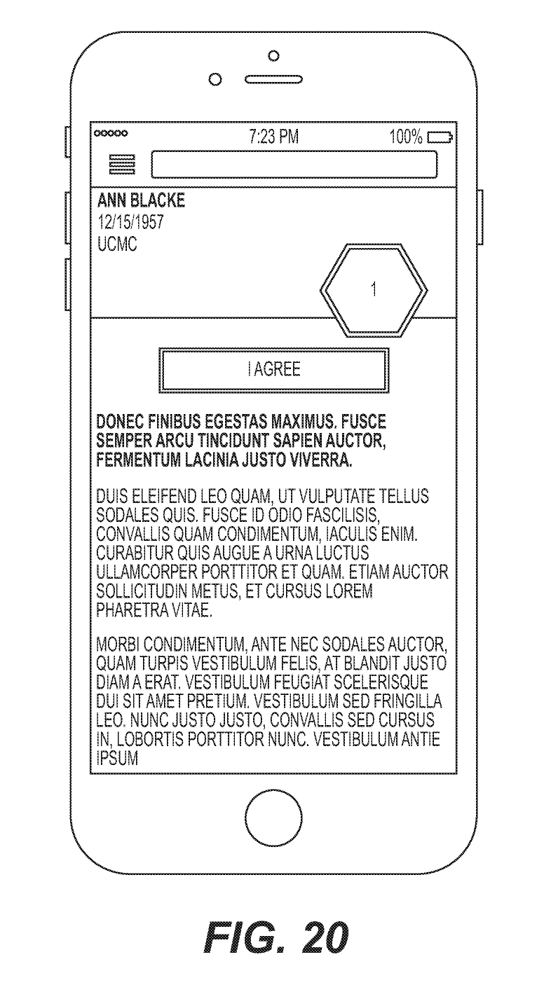

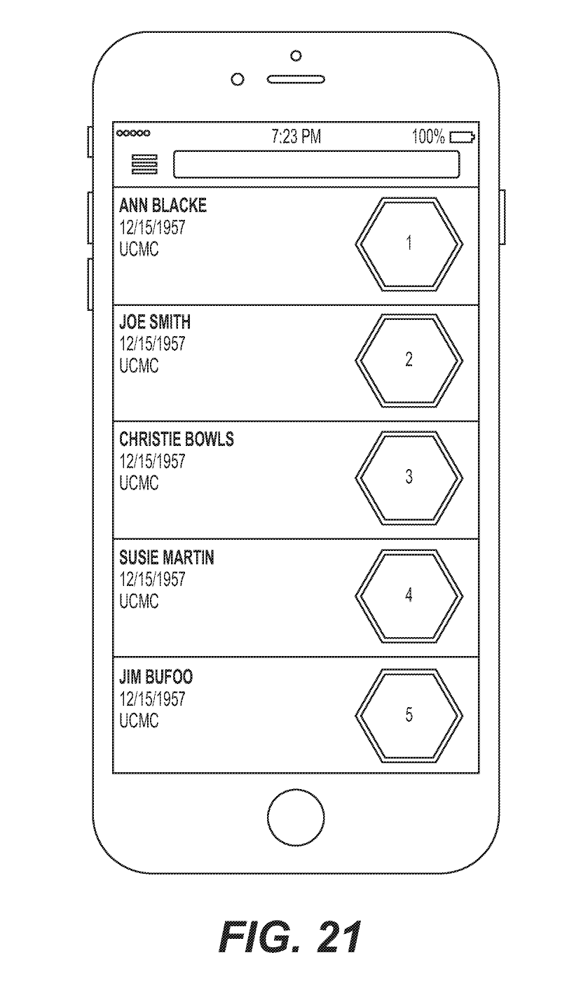

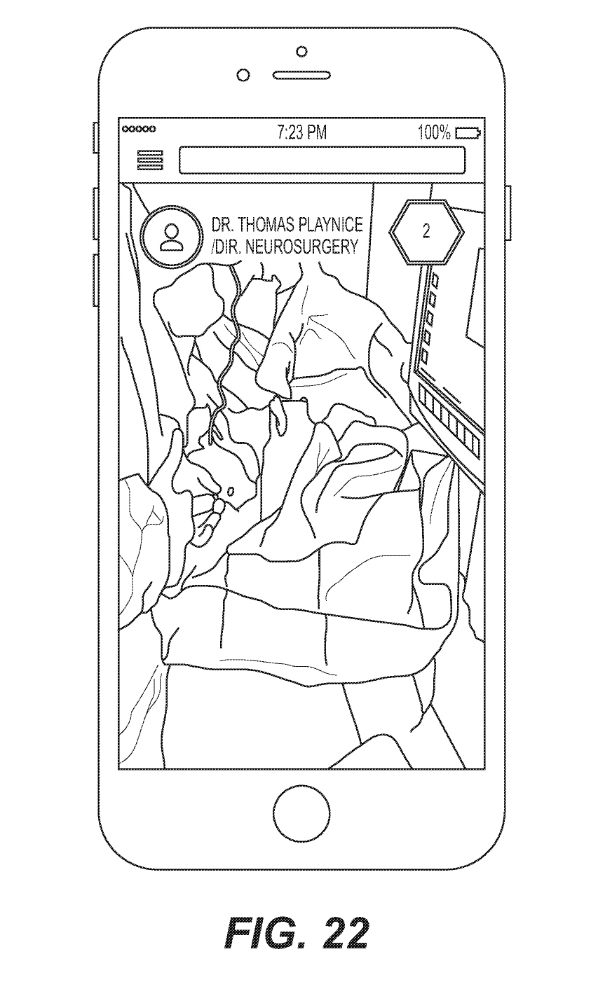

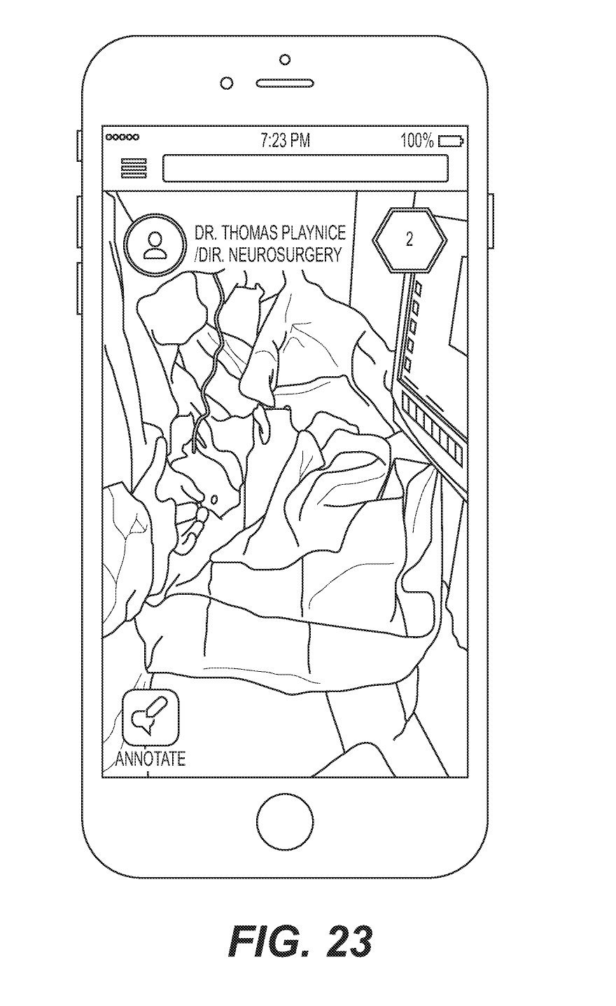

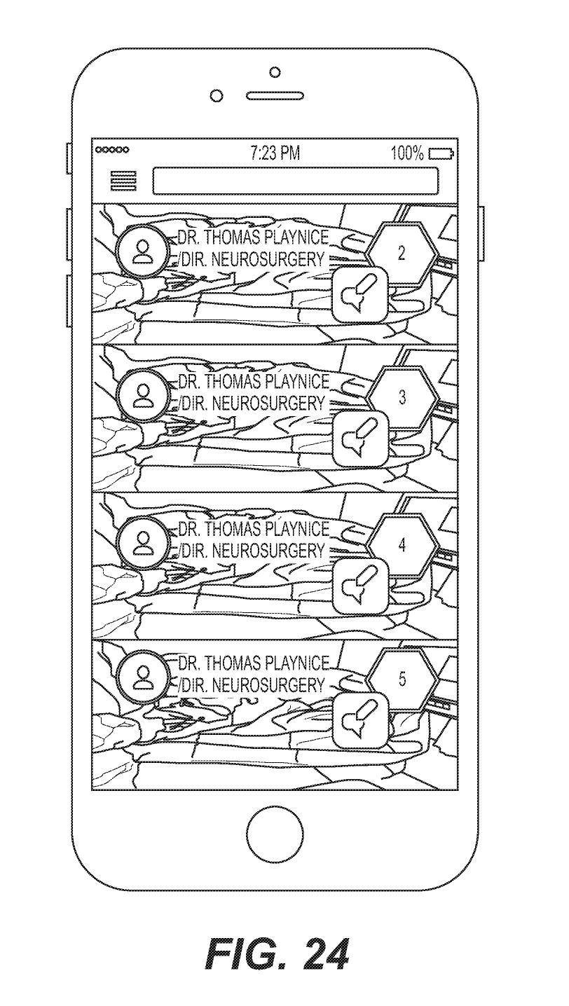

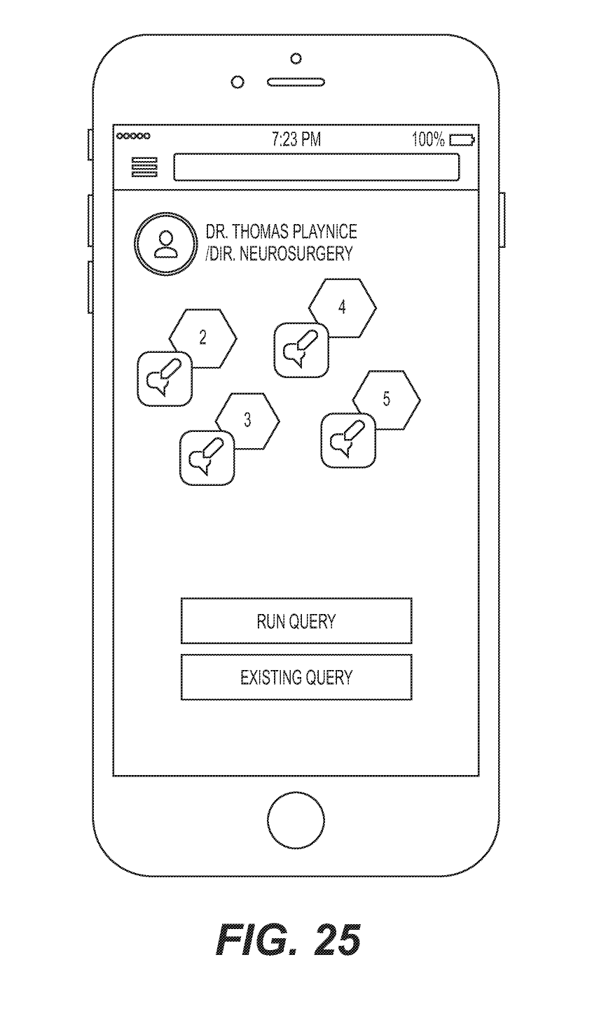

FIGS. 18-25 Observe & Record Sub Menus

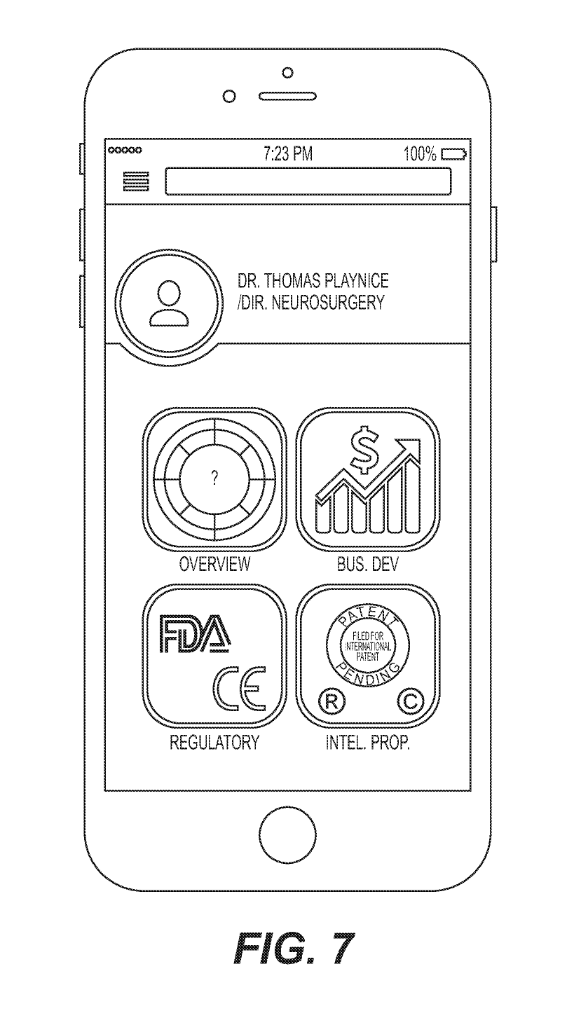

FIG. 7 highlights how a user can gain consent, choose from existing patients and record an observation. From here, users can annotate a clinical case and then run a query to determine patterns

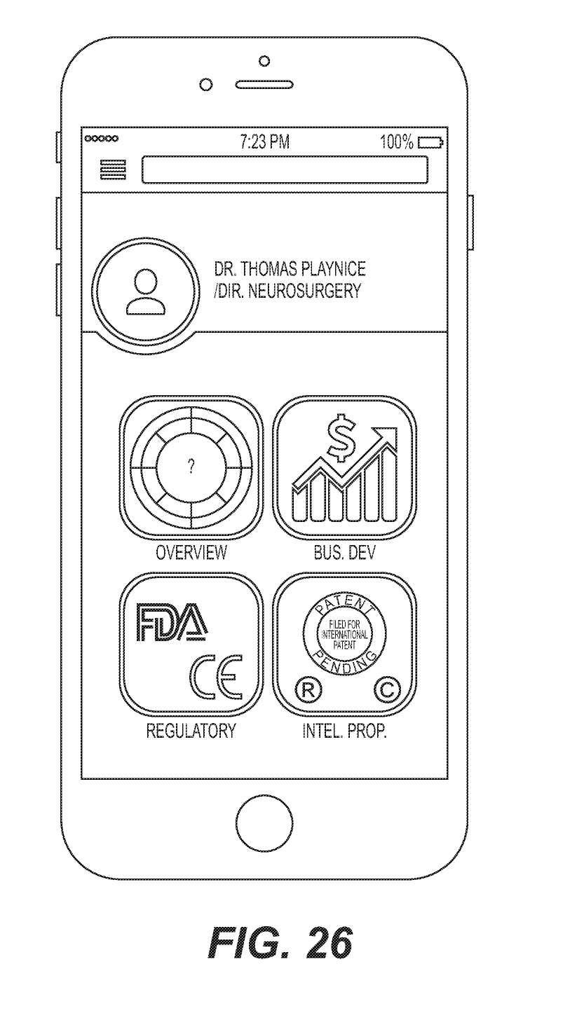

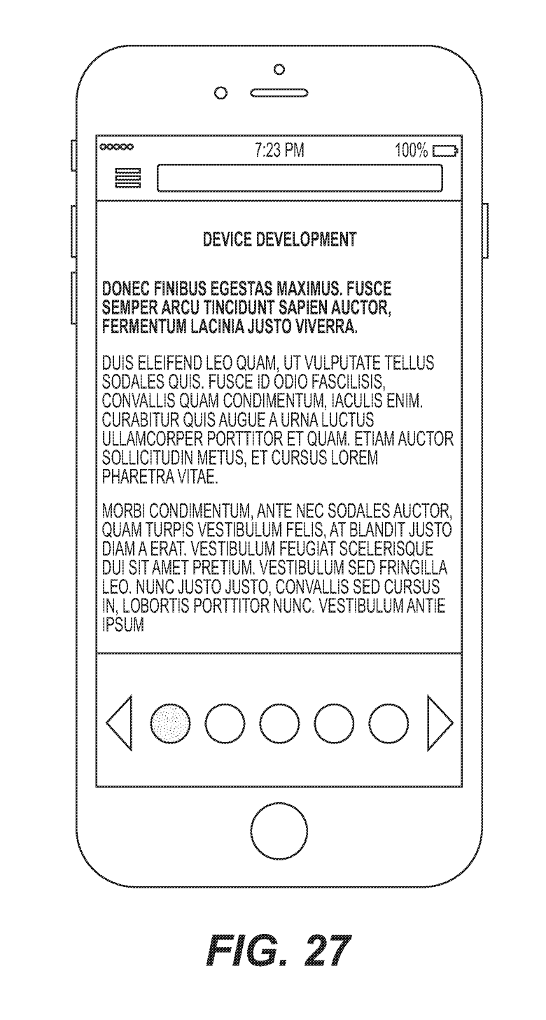

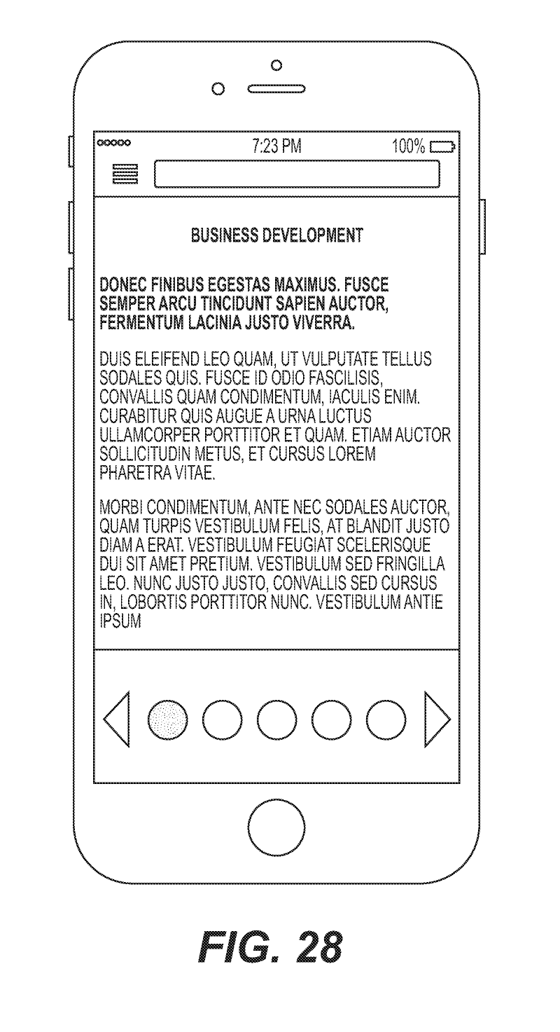

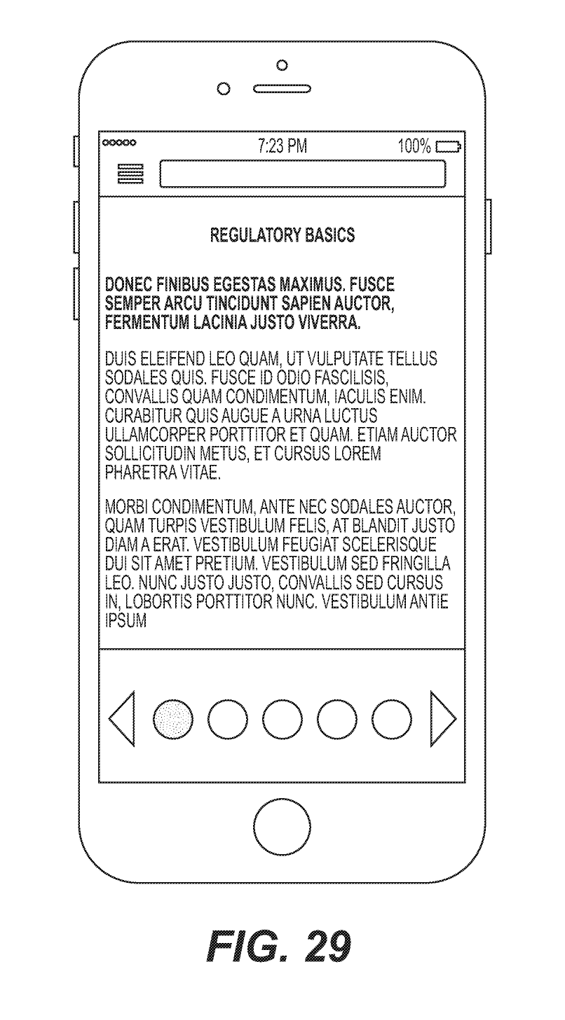

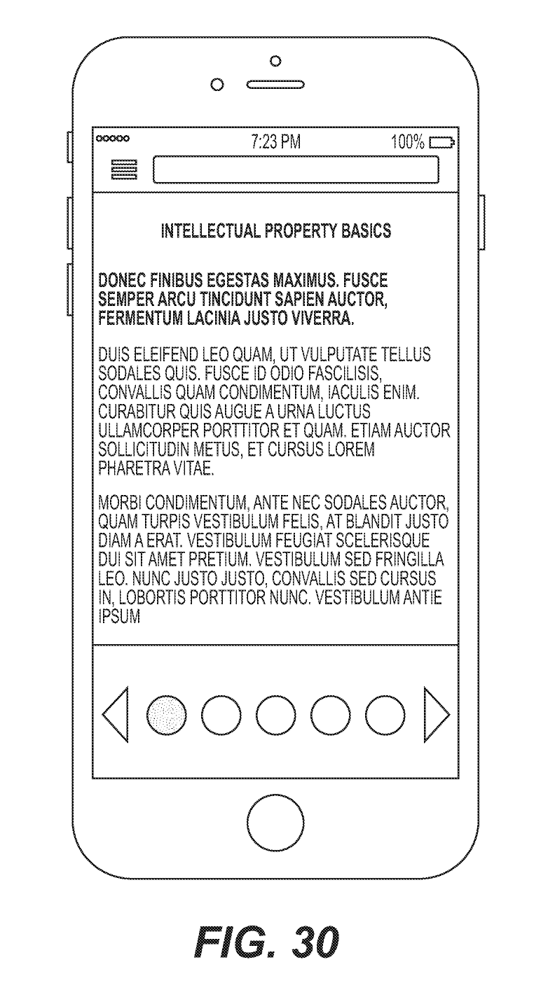

FIGS. 26-30 Discover Menu Options

FIG. 26 demonstrates the Discover menu wherein users can find a resource of information regarding medical device development, business influencers, agency and intellectual property basics.

Users tap an icon and find information pages regarding relevant topics. Users can use the search function to seek a particular topic. In addition, this section is lined to the project status section and can be used for further explanation as to where in the development process a device is currently phased. In addition, the business development section is also linked to this section in the event that a project is struggling and an explanation is warranted. The explanation can reference business practices within this section to allow users further depth of understanding if desired.

What is claimed is:

1. A computer application for structured research and development of medical devices comprising
a means for defining the scope of research,
and a means to document findings of the research,
and a means to readily access reference information related to the research topic,
and a means to document discoveries of the research for further development.

2. The computer application of claim 1 where the means of defining the scope of research includes a means to record specific clinical references including actual clinical practice, simulated clinical practice or animal/cadaveric labs,

3. The computer application of claim 1 where the means of defining the scope of research includes a means to link to reference databases which include clinical references

4. The computer application of claim 1 where the means of defining the scope of research includes a means to use linked references to clinical data to generate data collection forms, or a means to document characteristics of research participants, or a means to document specific names of research participants, or a means to identify regulatory guidelines related to research participants

5. The computer application of claim 1 where the means of defining the scope of research includes a means to limit data collection based on the identity of research participants or a means to allow defined research participants to access portions of the computer application.

6. The computer application of claim 1 where the means of defining the scope of research includes a means to link the research to prior research studies

7. The computer application of claim 1 where the means of defining the scope of research includes a means to identify regulatory guidelines related to researchers

8. The computer application of claim 1 where the means of defining the scope of research includes a means to link the research to prior research studies conducted by the researchers, or includes a means to link the research to existing products

9. The computer application of claim 1 where the means of defining the scope of research includes a means to link the research to clinical performance, use, or safety data associated with existing products

10. The computer application of claim 1 where the means of documenting the findings include generation of data collection forms based on the scope of the research

11. The computer application of claim 1 where the means of documenting the findings include generation of data collection forms which include anatomical images or physiologic reference data

12. The computer application of claim 1 where the means of documenting the findings include a means for using a computer camera to record observations, where said camera may include a means for linking the images captured to other data collected.

13. The computer application of claim 1 where the means of documenting the findings include a means for using a computer camera to record observations where the images captured are linked to research participant data.

14. The computer application of claim 1 where the means of documenting the findings include a means for using a microphone to record observations, where said microphone may include a means for linking the images captured to other data collected.

15. The computer application of claim 1 where the means of documenting the findings include a means for using a microphone to record observations where the sounds captured are linked to research participant data.

16. The computer application of claim 1 where the means of documenting the findings include a means for using a keyboard to record observations where notes captured through said keyboard may be linked to notes captured to other data collected.

17. The computer application of claim 1 where the means of documenting the findings include a means for using a keyboard to record observations where the notes captured are linked to research participant data.

18. The computer application of claim 1 where the means of documenting the findings include a means for using symbols, marks, or artistic references to recorded observations where the notes captured may further be linked to research participant data.

19. The computer application of claim 1 where the means of documenting the findings can be linked to means for automatically analyzing the data

20. The computer application of claim 1 where the means of readily accessing reference information includes gathering data from stored files within the computer application or from stored files outside of the computer application.

21. The computer application of claim 1 where the means of readily accessing reference information includes means of updating the accessed data to include collected research observations, or running a specific query.

22. The computer application of claim 1 where the means of documenting discoveries includes a means for using the computer camera, keyboard, microphone or interactive screen.

23. The computer application of claim 1 where the means of documenting discoveries includes a means to associate the discoveries to the inventors, or includes a means to associate the discoveries to the data requirements for a patent application or a regulatory submission or for post market surveillance.

24. The computer application of claim 1 where the means of documenting discoveries includes a means to associate the discoveries to the reference clinical or physiologic data or regulatory requirements or prior research studies, or prior product performance data.

25. The computer application of claim 1 where the means of capturing and communicating data is limited by participant privacy regulatory guidelines and allows participants to waive privacy regulatory guidelines.

26. The computer application of claim 1 where the data collection means or reference information can be updated automatically or remotely

27. The computer application of claim 1 where the multiple participants can access data collection means or reference information or discoveries either selectively or in whole.
